(19) United States
(12) Patent Application Publication
(10) Pub. No.: US 2024/0228331 A1
(43) Pub. Date: Jul. 11, 2024

(54) LIQUID TREATMENT METHOD AND APPARATUS

(71) Applicant: NOVOLABS LIMITED, Milson, Palmerston North (NZ)

(72) Inventor: Andrew Nicholas SHILTON, Palmerston North (NZ)

(21) Appl. No.: 18/573,390

(22) PCT Filed: Jun. 23, 2022
(86) PCT No.: PCT/NZ2022/050082

§ 371 Date: Dec. 21, 2023

(30) Foreign Application Priority Data
Jun. 25, 2021 (NZ) 777519
Aug. 24, 2021 (AU) 2021221445

(51) Int. Cl. C02F 1/32

(52) U.S. Cl. CPC C02F 1/325; C02F 2201/007; C02F 2201/3221; C02F 2201/3227; C02F 2201/3228; C02F 2209/40; C02F 2301/024; C02F 2303/14

(57) ABSTRACT

Apparatuses for treating liquids and methods of using the apparatuses. A treatment apparatus can have a conduit, a radiation source and a slot. The slot can have a height greater than 6 mm and allows liquid to flow into the conduit in a supercritical flow. A liquid treatment apparatus can include a plurality of treatment modules with separate liquid flows. The modules can be pulled out from the module without disconnection of the modules from a liquid source or drain. The modules can have lids to allow access to their interiors. An inlet component for producing a supercritical flow is also disclosed.

### FIELD

This invention relates to a method and apparatus for treating a liquid using radiation.

### BACKGROUND

Systems employing UV light bulbs sources provided in quartz tubes within a flow of liquid to be treated are widely employed. Any system where the ultraviolet radiation source(s) is submerged in the liquid has electrical connection and associated waterproofing complexities.

Systems employing UV radiation typically convey flow through a conduit in which multiple UV bulbs are installed, if a bulb fails then either the entire flow through the unit must be ceased or the flow will continue at a reduced UV dose until an operator can respond and replace the bulb. A reduced UV dose reduces the UV treatment efficiency of the system. Alternatively, there needs to be additional redundancy built into the system which is on standby in case of bulb failure.

While some systems incorporate automatic wiping systems for the outside of quartz sleeves, from time to time operators need to access areas of a treatment system for a manual clean and other maintenance. In some existing systems that use open channels, in order to change a bulb or to undertake a manual clean of the quartz tubes a whole bulb and quartz tube assembly along with the power leads and supporting frame sometimes need to be disconnected and lifted out, dripping and wet. Alternatively in a pressurised system, to access the outer surface of the quartz tubes for a manual clean the system must be stopped, drained, and then the tubes removed from the system. In both cases this is inconvenient and time-consuming. The quartz tubes are long and reasonably delicate. Moving racks of bulbs/quartz sleeves out of a channel or extracting these one by one from a pressurized system creates the risk of breakage. Furthermore, it may also be unhygienic and messy with liquids such as wastewater effluents dripping onto surroundings and/or getting onto operators which is a health hazard and is unpleasant.

The various issues and complexities discussed above add to the cost and difficulty of constructing and maintaining many prior art systems.

To achieve an acceptable degree of treatment of a liquid, a suitable dose of UV radiation must be delivered to the liquid. The dose is defined as the product of the radiation intensity and the duration for which the liquid is exposed to the radiation, which is also known as the retention time.

When using radiation to treat liquids, it is important to note that the liquid may contain material that discolours, obscures, or otherwise reduces the transmissibility of the radiation through the liquid. For example, even seemingly clear liquids like Sprite™ or white wine can also have low ultraviolet light transmissivity (UVT) due to their dissolved solids. Low transmissivity reduces the radiation available for treatment within the liquid and decreases the effectiveness of treatment.

Many prior art systems are incapable of providing viable (in terms of cost and/or treatment effectiveness) treatment to fluids of low UVT and, for example, specify that the UVT needs to be approximately 60% or higher.

Other prior art systems aim to treat lower UVT liquids by the provision of increased radiation input per unit of flow but this results in higher costs.

Some prior art aims to reduce the depth of the fluid being irradiated by creating a thin flow/film. This may reduce the high transmission losses of the radiation that occurs in low UVT liquids. However, systems with thinner flows typically have lower flow throughput than systems with thicker flows.

Treating supercritical flow with radiation has advantages however experimental testing has revealed that triggering supercritical flow from a sluice gate or slot out into a conduit can result in intermittent elements of liquid ejecting upwards from the supercritical flow in the conduit. While this is a relatively minor effect over a short period of operation for example minutes to hours by contrast over an extended period of operation for example days to weeks this can result in an undesirable amount of fouling of any radiation source, reflectors or radiation transmissive window in close proximity.

Another flow treatment system is known from WO2017111616, the contents of which is incorporated herein by reference.

### SUMMARY

According to one example there is provided an apparatus for treating a liquid, the apparatus including:
i. a conduit;
ii. a slot having a height greater than 6 mm, the slot configured to allow liquid flow into the conduit to generate a supercritical liquid flow along the conduit; and
iii. at least one radiation source external to the flow to irradiate the flow.

According to another example there is provided a method of treating a liquid including:
i. generating a flow of the liquid in a supercritical flow and having a depth equal to or greater than 6 mm; and
ii. irradiating the flow using at least one radiation source external to the flow.

According to another example there is provided an apparatus for treating a liquid, the apparatus including:
i. a frame; and
ii. a plurality of treatment modules supported by the frame, each treatment module having one or more liquid conduits therethrough and one or more radiation sources for treating the liquid in that module;
wherein the apparatus is configured to treat a plurality of separate flows of liquid through respective separate ones of the treatment modules;
and wherein at least one of the treatment modules has an opening lid and the module is movable relative to the frame and allows access into the module when its lid is open.

According to another example there is provided an apparatus for treating a liquid, the apparatus having a frame and one or more treatment module(s) where each module includes:
i. a liquid inlet for receiving liquid from a liquid source;
ii. a liquid outlet for discharging liquid to a liquid drain;
iii. one or more liquid conduits between the liquid inlet and the liquid outlet; and
iv. one or more radiation sources for treating the liquid in that module; wherein one or more of the treatment modules is movable relative to the frame without disconnection of the module(s) from the liquid source or disconnection of the module(s) from the liquid drain.

According to another example there is provided a method of operating a liquid treatment apparatus, the apparatus including a plurality of liquid treatment modules, wherein the apparatus is configured to treat a plurality of separate flows of liquid through respective separate ones of the liquid treatment modules,

wherein each liquid treatment module has one or more radiation source(s) for treating the liquid flowing through one or more conduit(s) of that module and wherein at least one of the treatment modules is movable and has an opening lid, the method comprising:
moving one of the treatment modules;
opening the lid of the moved treatment module; and
accessing the interior of the moved treatment module.

According to another example there is provided a method of operating a liquid treatment apparatus, the apparatus including a frame and one or more liquid treatment modules, each module including: a liquid inlet for receiving liquid from a liquid source; a liquid outlet for discharging liquid to a liquid drain; one or more liquid conduits between the liquid inlet and the liquid outlet; and one or more radiation sources for treating the liquid in that module; wherein the method comprises:
moving one or more of the treatment modules relative to the frame without disconnecting the module(s) from the liquid source or disconnecting the module(s) from the liquid drain.

According to another example there is provided a liquid treatment module comprising:
i. a body containing a conduit for conveying a liquid to be treated from an inlet to an outlet;
ii. a lid including one or more radiation sources for treating a liquid flowing through the conduit; and
iii. one or more radiation-transmissive windows configured to enclose the radiation source(s) when the lid is closed and the module is in use;
   wherein the lid is movable relative to the body from a closed position to an open position.

According to another example there is provided a liquid treatment apparatus including:
a liquid conduit;
a liquid inlet component configured to provide a supercritical flow of liquid to the liquid conduit for treatment, wherein the liquid inlet component comprises one or more walls configured to define a liquid passage through the liquid inlet component, the liquid passage comprising:
   i. an entry section having a first dimension transverse to a direction of flow of liquid through the entry section and a second dimension transverse to the direction of flow of liquid through the entry section and perpendicular to the first dimension;
   ii. an exit section terminating in an exit slot, the exit section having a length, an exit section height that is less than the first dimension of the entry section and an exit section width that is greater than the second dimension of the entry section, wherein the exit section height and the exit section width are substantially unchanged over the length of the exit section; and
   iii. a transitional section between the entry section and the exit section, wherein the transitional section has a transitional section width that is greater than the second dimension of the entry section and a transitional section height that is greater than the exit section height.

According to another example there is provided a liquid treatment apparatus including:
a liquid conduit;
a liquid inlet component configured to provide a supercritical flow of liquid in the liquid conduit for radiation treatment of the supercritical flow, wherein the liquid inlet component comprises one or more walls configured to define a liquid passage through the liquid inlet component, the liquid passage comprising:
   i. a first section terminating in an exit slot from which liquid exits the liquid inlet component, the first section having a length, a height and a width, wherein the height of the first section and the width of the first section are substantially unchanged over the length of the first section; and
   ii. a second section upstream of the first section, the second section having a height that is greater than the height of the first section, wherein the second section is configured to receive a flow of liquid and direct the flow of liquid into the first section.

In some examples the conduit is an open channel.

Examples may be implemented according to any of the dependent claim 2-31, 33-38, 40-45, 47-63, 65-79, 81-94, 96-110, 112-131 or 133-145.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e., they will be taken to mean an inclusion of the listed components which the use directly references, and possibly also of other non-specified components or elements.

Reference to any document in this specification does not constitute an admission that it is prior art, validly combinable with other documents or that it forms part of the common general knowledge.

### BRIEF DESCRIPTION OF THE DRAWINGS

The accompanying drawings which are incorporated in and constitute part of the specification, illustrate embodiments of the invention and, together with the general description of the invention given above and the detailed description of embodiments given below, serve to explain the principles of the invention.

FIG. 1 is a cross-sectional side view of a liquid treatment apparatus according to one example;

FIG. 2 is a perspective view of a liquid treatment apparatus according to another example in one state;

FIG. 3 is a perspective view of the liquid treatment apparatus of FIG. 2 in another state;

FIG. 4 is a cross-sectional side view of a liquid treatment module according to one example;

FIG. 5 is perspective view of a liquid inlet component according to one example;

FIGS. 6a-6e are perspective views of liquid inlet components according to further examples; and

FIGS. 7a-7c are perspective views of liquid inlet components according to further examples

### DETAILED DESCRIPTION

The invention will be described by way of examples employing ultraviolet (UV) radiation but it is to be appreciated that in appropriate circumstances that other forms of radiation may be employed. The invention will also be described by way of examples employing quartz but it is to be appreciated that in appropriate circumstances that other forms of material that are transmissive to radiation may be employed.

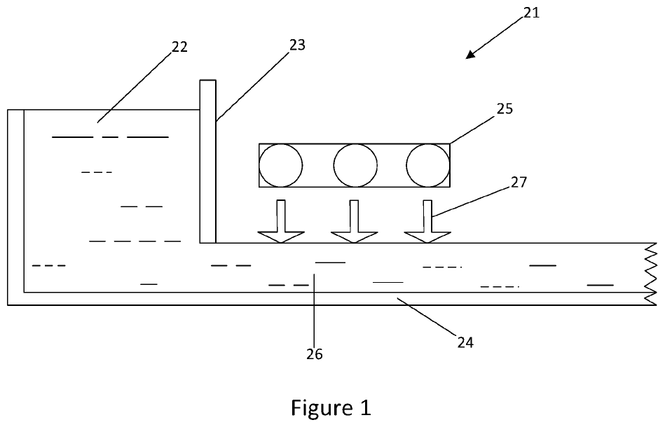

FIG. 1 shows a liquid treatment apparatus 21 according to an exemplary embodiment. The source 22 of a liquid to be treated may be a header tank or other reservoir that maintains a gravity liquid pressure that provides the driving energy for the flow exiting source 22. A gate 23 is used to restrict the flow of liquid exiting from source 22 to generate a flow of the required depth and flow rate. The gate 23 may be a sluice gate, valve, a fixed slot or any other suitable means for controlling the flow including any suitable arrangement of one or more apertures in a barrier.

The channel 24 that the liquid flows in is enclosed by a bottom face and side faces, leaving the top face open, or at least not in contact with the liquid. This type of liquid flow within a conduit with a free (unconstrained) liquid surface is known as “open channel flow”. The open channel design allows the arrangement of one or more ultraviolet radiation sources 25 above the open top face of the channel. In some examples, a channel, or module with one or more channels/conduits, with a width of 1 m or less may be particularly well suited for enabling practical access into channels or modules that have a lid attached. In some examples a channel or conduit having a depth of 100 mm or less may be particularly well suited to systems used in a frame or rack or in a smaller-scale treatment system which has lower flow throughput requirements, for example for treating milk or beverages. In other examples, greater widths and/or depths may be used.

The gate 23 creates an opening in the form of a slot between the gate and base of the channel 24. This allows a flow 26 of liquid to flow out of the source 22. Various different slot heights, producing various different flow thicknesses, may be useful for different applications.

In some applications, there are advantages to using a slot height of about 6 mm or greater or about 7 mm or greater to produce a flow thickness of about 6 mm or greater or about 7 mm or greater. Thicker flows may require less pressure or energy to move the liquid through the treatment apparatus. This advantage would increase as flow rates increased. It may also have the advantage of reducing or avoiding the chance of partial blockages of the slot, or other type of opening, where the liquid enters the flow conduit. Any such blockages can cause flow disturbances and splashing when operating a system with a supercritical flow that potentially fouls internal parts of the apparatus such as a quartz window or bulbs, etc. Blockages may be particularly likely when the liquid contains or is contaminated with small solids, for example crop residues in vegetable-processing effluent; or debris (such as a duck feather or pine needle, etc) that fall into upstream wastewater treatment units. Smaller slots may be more prone to blockages than larger ones and may require screens upstream of the slot to remove debris and other solids. Larger slots may avoid the need for such screens or increase the suitable mesh size for such screens, thereby reducing their resistance to fluid flow.

A high velocity flow of a liquid may be created by storing the liquid in a reservoir as shown in FIG. 1 and exploiting its gravitational potential energy by locating the gate 23 at the bottom of the reservoir. This apparatus is analogous to a dam in a river. When the gate 23 is opened, the liquid can be discharged at a relatively high velocity. Alternative embodiments of the invention may utilise a fixed slot instead of the gate or may instead of an open reservoir utilise a reservoir enclosed at the top that can be pressurised by a pump, or other mechanical device, so that the liquid is ejected from the gate 23 (or slot) into the channel.

It has been found that to achieve a high throughput whilst ensuring adequate treatment that a supercritical flow can be employed. A supercritical flow is a rapid and shallow flow through an open channel (as opposed to constrained, pressurised flow also sometimes known as “pipe” flow) and is defined as set out below.

The Froude Number of a flow is defined as:

$$Fr = \frac{y}{\sqrt{yg}}$$

### Where:

Fr=the Froude number
v=velocity of flow (m/s)
y=depth of flow (m)
g=acceleration due to gravity (m/s²)

By definition, Fr must be greater than 1 for a flow to be in a supercritical state.

By manipulating the Froude Number equation, v=Fr\sqrt{yg}

Since Fr>1 in a supercritical flow, for a depth of flow y the flow velocity for having a supercritical flow must be:

$$v > \sqrt{yg}$$

Given a depth for the flow 26, for example as set at a gate or slot, it is possible to calculate the flow velocity required (and flowrate throughput) so that supercritical flow conditions prevail.

Supercritical flows with high velocities are often turbulent. In experiments comparing supercritical laminar flow against supercritical turbulent flow, the treatment performance was superior for turbulent flow.

Once the flow 26 flows through the gate 23, the treatment process begins. The ultraviolet radiation sources 25 may be a plurality of tubular ultraviolet light bulbs with reflectors to direct as much of the radiation into the liquid to be treated as possible.

The apparatus 21 of FIG. 1 can be configured to produce and treat a flow 26 that is 6 mm thick or greater, for example 7 mm or greater.

In this apparatus 21, the gate 23 can have a slot of 6 mm or greater, for example 7 mm or greater.

The intensity of radiation, such as UV light, decreases exponentially as it penetrates into a liquid. It may be expected that treatment (as measured by reduction in contaminant count due to the treatment) would decrease with increasing liquid thickness (depth). For example, in experiments using irradiation of supercritical flow both orange juice and apple juice diluted to a UV transmissivity (UVT) of 0.2% were treated more effectively at a thickness of 2 mm than at a thickness 4 mm (depth measured at the entry point to the supercritical flow channel). In these experiments treatment efficiency continued to decrease as the liquid flow thickness further increased. Similar results have been observed for other liquids including effluents.

However, it has now been found that in some cases better than expected results may be achieved when treating supercritical flows that are thicker than this. For example, in further tests of the orange and apple juices, it was found that when the UVT was improved to 25% by further dilution more efficient treatment was often obtained for thicknesses of 4 mm and 6 mm as compared to 2 mm. In other testing on an effluent (UVT of 22%) depths of 8 mm and 10 mm were found to be superior to 2 mm and 3 mm.

Without intending to be bound by theory, it is possible that in some of the examples above, at low UVTs the majority of the radiation is fully absorbed into the liquid at the thicknesses tested, but at higher UVTs a significant amount of the radiation might pass into the liquid, reflect off the base and then leave the liquid after which would it then be subjected to further inefficient reflection/transmission losses in the lid above the treatment channel. However, in these higher UVT cases as the liquid thickness increases, more of the radiation would be absorbed and not leave the liquid.

However, it appears that the factors involved are more complex than can be explained by a simple relationship to UVT alone. In experimental testing of a liquid with a UVT of 2.5%, it was found 7 mm achieved slightly better treatment than 3 mm whereas for testing on apple juice diluted to a very similar 2% UVT, the more normal expectation still held true with 2 mm being better than 4 mm, 4 mm being better than 6 mm and 6 mm being better than 8 mm, etc.

The factors that affect treatment are multiple and complex. For example, while the concentration of solids in a liquid are known to affect UVT and treatment, it also depends on the nature of the solids. For example, solids which enable bacteria to be shielded within their bodies are harder to treat than liquids where bacteria are restricted to the outside of the solids. Because the various factors that affect treatment are multiple and complex, a simple measure of UVT cannot be used to predict when larger flow thicknesses are viable. However, this can instead be simply determined by site-specific testing.

Being able to effectively treat thicker supercritical flows of suitable liquids has multiple advantages. It may allow adequate treatment to be achieved at higher flow rates, or more thorough treatment at a similar flow rates. Using thicker flows also reduces the chance of blockages occurring in the inlet because of the greater slot height used.

Supercritical flows having thicknesses y of 6 mm or greater can be achieved by ensuring that the velocity v of the flow is great enough that the Froude number Fr is greater than 1 for the given thickness y.

Reflectors (not shown in FIG. 1) may be provided near the radiation sources 25 to ensure that the maximum amount of ultraviolet radiation is directed into the liquid. The reflectors may be parabolic and the bulbs may be placed approximately at the focuses of the reflectors. Other reflector configurations are also possible, such as flat reflectors, however these may be less effective at directing the ultraviolet radiation. The ultraviolet light sources may also be LEDs, which may be configured so that the radiation is emitted substantially in one direction, reducing the need for reflectors. In either case, it is preferable that the light path is as perpendicular to the liquid surface as possible so that as much light as possible enters the liquid without reflecting off the liquid surface.

In some examples, a plurality of apparatuses 21 can be provided as modules within a larger treatment apparatus. For example, the apparatuses 21 can be stacked on each other or supported by a frame. The apparatuses can be fluidly connected in parallel so that liquid flowing through each module forms a separate flow from liquid flowing through the other modules.

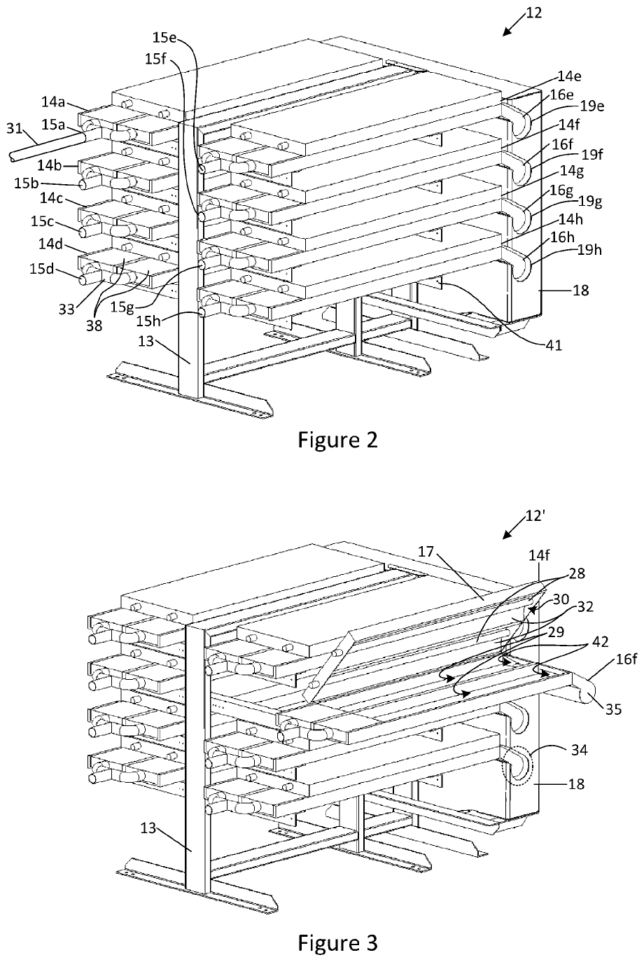

FIG. 2 depicts a liquid treatment apparatus 12 that has several modules 14a-14h supported on a frame 13. The modules are movably supported so that they can move while supported by the frame 13. In this example, the frame 13 is a rack to which the modules are slidably mounted. The modules can slide out of the rack when pulled by an operator. In the example shown in FIGS. 2 and 3, the frame 13 is a rack with rails 41 (only one rail labelled) supporting the modules 14a-14h. The modules could alternatively be rotatably mounted or mounted on linkages. In alternative examples, the frame could be in a different form, such as a tree having a central post with the modules arrayed around the post and rotatably connected to it at their edges. Alternatively, the frame could be a table with the modules arranged side-by-side on the table. In the example shown in FIGS. 2 and 3, all of the modules 14a-14h are movable with respect to the frame. In other examples, one or more of the modules need not be movable. For example, the upper most modules 14a and 14e may be fixed in place because these modules would be accessible from the top without being pulled out.

The modules 14a-14h can be configured to support open channel flow through their respective conduits 29 in which the upper surface of the liquid is not constrained by e.g. a top wall. The modules 14a-14h can be configured to support supercritical flow through their respective conduits 29. Alternatively, the modules 14a-14h can be configured to support any other type of open channel flow hydraulics including critical flow or sub-critical flow or alternatively the conduits 29 can be enclosed at the top and fully filled with the liquid flowing through under pressure.

The modules 14a-14h can be arranged to operate in parallel to each other, i.e. they provide separated flow paths for separate portions of the liquid. While the flows are parallel in a fluid flow sense, they need not be parallel in a geometric sense and can be at various angles to each other. The liquid flows through the apparatus 12 in a plurality of separate flows, each of the separate flows through separate modules. The flows may be split into separate flows by a flow separator constructed as part of the apparatus 12 or the apparatus 12 could receive flows that are already separate from each other, e.g. from separate supply hoses.

Each module 14a-14h can be connected to a liquid supply via a respective one of the inlets 15a-15h. Each inlet receives flow and then distributes and discharges it through a slot(s) into its module's respective conduit(s). In the example of FIGS. 2 and 3, the inlets 15a-15h are structural bodies that convey liquid. In other examples, each inlet could simply be a hole or other opening for allowing a liquid to enter a treatment device/module.

The modules 14a-14h may be connected to a common liquid supply or to different liquid supplies. Liquid enters the modules 14a-14h through the inlets 15a-15h then flows through one or more conduit(s) (indicated at 29 in FIG. 3) in each module. Within each module, there may also be a plurality of separate (i.e. parallel) flows. In the example of FIGS. 2 and 3, each module has two parallel (in the fluid flow sense) conduits. In this example, the inlet includes a y-junction 33 (only one labelled for clarity) that feeds liquid into two small reservoir blocks 38, one for each of the two conduits. The reservoir blocks 38, which are filled with liquid under pressure, eject the liquid through a slot and out into the conduits of the module.

The liquid inlets 15a-15h can be connected to flexible inlet conduits such as hoses 31 (only one shown for clarity). In other examples concertina conduits or telescoping conduits could be used in place of the flexible inlet conduit. Alternatively, the liquid inlet could be slidably or pivotably connected to the liquid source to remain connected while moving. In the example including hoses, when the modules are moved the hoses from the liquid source can simply flex to permit the movement while maintaining a liquid-tight connection to the modules.

Liquid exits the modules 14a-14h via gaps into respective outlets (the gaps 42 of one module 14f are shown in FIG. 3) and is then discharged into the liquid drain 18. The outlets 16e-16h for modules 14e-14h are shown in FIGS. 2 and 3. Similar outlets (not visible in the views of FIGS. 2 and 3) would be provided for modules 14a-14d. An outlet is attached to the end of the conduits of each module and receives liquid from that module and conveys the liquid into the liquid drain 18. In the example of FIGS. 2 and 3, the outlets are structural bodies that convey liquid. In other examples, each outlet could simply be a hole or other opening for allowing a liquid to exit a treatment device/module. The outlets remain connected to the drain in a liquid flow sense in that the flow paths from the outlets to the drain remain unbroken when the modules are moved and any liquid flowing from the outlet can enter the drain. The outlets need not be structurally connected to the drain, for example they can reside within recesses in the drain without needing direct structural connection to it. One example of this is shown in FIGS. 2 and 3.

As shown in FIGS. 2 and 3, the outlets 16e-16h include covered gutters with part-circular cross sections connected to the modules by generally trapezoidal prism-shaped pieces. The gutters are closed at their outward-facing ends 35 (only one labelled for clarity) to prevent liquid from exiting the apparatus at that end but are open at their inward-facing end allowing the liquid to discharge out into the drain. In this example recesses are provided in the drain 18 to receive the outlets. Recesses 19e-19h are shown in FIGS. 2 and 3—similar recesses would be provided to receive outlets 16a-16d. As shown in this example, the recesses 19a-19d are generally cylindrical. The outlets can fit within the recesses and discharge flow into the body of the liquid drain 18 from the inner end of their gutter. The point at which the outlets discharge flow always remains within the liquid drain 18 so that even when the modules are pulled out any liquid discharging or dripping from the modules 14a-14h is contained and does not run or drip outside of the treatment apparatus 12.

In the example shown in FIGS. 2 and 3, the module outlets are not directly connected to the drain 18 but discharge flow via the outlets 16a-16h that can move freely within the recesses 19a-19d. In other examples liquid outlets such as flexible, slidable or pivotable conduits such as hoses, concertina conduits or telescoping conduits could be connected to the drain so that they remain connected when the module is moved which avoids the need to disconnect it and avoids any liquid discharging or dripping outside the drain of the apparatus.

In other examples, a separate drain can be provided for each module in place of the common drain 18 of FIGS. 2-3. The drains can be connected to one or more common collectors which in turn lead out an outlet for outputting treated liquid. Separate electronics units can also be provided for each module, for example containing the electrical control and power supply for the bulbs associated with each module. These separate electronics may, for example, be attached to the bottom of each module in a separate container. This container may be accessible when the module slides out of a rack of modules. These modifications to the drain and the electronics units improve the modularity of the treatment apparatus. Further, the location of the electronics unit, for example when located under the flow channel/s, can also enable some amount of heat from the electronics to be removed by the liquid flowing through the module that it is attached to (for example by heat conduction via the walls of the electronics container and the module and into the flow).

The construction of the apparatus 12 allows the modules to be moved and accessed without having to be disconnected first. This prevents liquid from dripping from the apparatus 12 or liquid supply when the modules are moved, avoiding mess and potential contamination.

It will be appreciated that the liquid source and liquid drain connections of the module that allow it to be moved without disconnection or dripping could be applied to a treatment apparatus with only one treatment module, as well as one with a plurality of modules as in the example shown in FIGS. 2 and 3.

In the example of FIGS. 2 and 3, the liquid drain 18 is in the form of a collection box, however in alternative examples the liquid drain could be a manifold or other conduit arrangement for collecting liquid and draining it into a separate holding tank or down a drain external to the apparatus.

A cover may be provided over the end of each recess 19a-19d in the region 34 generally indicated at the end of recess 19d. This may block radiation from exiting the apparatus 12 via the recesses 19a-19d. In one example, the cover may be a metal flap. The metal flap may be hinged to the body of the liquid drain 18 near the respective recess so that it can be pushed open by the module when the module is pulled out and hinge closed when the module is pushed back in.

In the state of the apparatus 12 shown in FIG. 2, all of the modules 14a-14h are in their retracted positions in the frame 13. In the state of the apparatus 12′ shown in FIG. 3, one of the modules 14f has been pulled out horizontally from the frame 13 to allow an operator access to the module. The lid 17 of module 14f has also been opened. This allows an operator to access the interior of the module 14f for cleaning, repair, inspection or other maintenance. Each module would have such a lid 17, and references to features of the lid 17 equally apply to the lids of the other modules. With the lid 17 of module 14f open, the conduits 29 and outlet gaps 42 of the module 14f can be seen. The arrangement shown in FIGS. 2 and 3 may allow an operator to access the module, including its interior, in only seconds. The operator could simply pull the module out from the frame and open the lid to gain access to the interior of the module. This is in contrast to prior systems, which can require more time consuming and inconvenient disassembly to access interior components such as conduits, quartz tubes and bulbs.

The radiation sources (e.g. UV bulbs 28) can be located in the lid 17. The lid 17 can also have reflectors 32 associated with the UV bulbs 28. One or more windows (not depicted with solid lines due to its transparency, but generally indicated by the arrow 30) made of a radiation-transmissive material can be provided on the lid 17. The radiation-transmissive material can be selected to allow at least some of the wavelengths of radiation produced by the radiation source to pass through to the liquid without major attenuation. For example, when the radiation sources are UV sources the window can be made of a UV-transmissive material. The window 30 may be made of quartz, which allows UV radiation to pass through largely unattenuated. In other examples, the window 30 could be made of other materials such as UV-transmissive plastic, for example Perfluoroalkoxy alkanes (PFA); Ethylene Tetrafluoroethylene (ETFE) etc may be suitable. A window may consist of a single pane or may have multiple adjoining panes. In this example, the window forms the base of the lid 17, although in other examples the window 30 could be embedded in the lid 17, hinged to the lid 17 or conduit 29, or separable from the lid 17. The window may be placed between the lid 17 and the conduit. The window may be latchable to the lid or to the conduit. The window may be provided with one or more seals to provide a substantially liquid-tight seal between the window and the conduit and/or between the window and the lid 17. With the lid 17 open, an operator can, for example, access the conduits 29 to clean the walls of the conduits or to clean the window 30 or to clear blockages from the slot where the liquid enters the conduits from the inlet 15. If a window is not fixed to the lid the bulbs 28 and reflectors 32 can also be directly accessed if desired. The conduits 29 and other parts of the flow path such as the slot that passes liquid into each conduit are located in the body of the module, not the lid. This means that the slot and conduit are not directly affected by the opening of the lid. In some situations, a user may allow flow to continue while the lid is open and the radiation for that module is turned off to inspect flow through the slot and/or conduit.

The windows 30 can enclose the UV bulbs 28 in a space in the lid 17 and help protect them from contamination. The UV bulbs are most efficient when operating within a specific temperature range which may be above ambient temperature. In order to regulate the temperature of the bulbs 28, airflow controllers may be provided to control a flow of air through the enclosed space. These may include passive airflow controllers such as vents or active airflow controllers such as fans. The ambient air may be relatively cool and may be used to cool the radiation sources. Generally cooling air may be provided, but in some cold climates, it may be desirable to warm the air. The air supply used for temperature regulation may be pre-cooled or pre-warmed by a heat pump. In other examples, one or more active cooling or heating elements (e.g. a Peltier element or heater wire) may be used to cool or warm the flow of air used for temperature regulation.

In some examples, the flow of liquid through any individual module can be inhibited (i.e. reduced or stopped by a controllable valve). For example, the flow through a module can be inhibited when the lid of that individual module is opened. Operation of the radiation source (e.g. UV bulbs) of any individual module can also be inhibited. For example, operation of the radiation source of a module can be inhibited when the lid of that module is opened. One or more sensors can be provided on the lid and/or on a module to sense opening of the lid and cause one or more flow and/or radiation controllers to inhibit the flow and/or radiation for that module.

The embodiment of FIG. 1 may have similar lid, window and/or temperature regulation arrangements to those discussed with respect to FIGS. 2 and 3.

The flow of liquid through a module, e.g. one of the modules 14a-14h of FIGS. 2 and 3, can be stopped when the module is moved out from the frame. One or more sensors can be provided to sense when the module is moved with respect to the frame and cause the flow controller to stop flow through that module. Flow through the other module(s) can continue as normal.

The provision of parallel modules allows one or more to be taken offline while others remain in use. For example, one module may need to be taken offline because a bulb has stopped working. Flow through this module can be stopped until the bulb has been replaced, while the other modules continue treating the liquid. In another example, the number of modules in use can be selected based on a desired throughput. Flow of liquid can be provided through a subset of the modules to achieve the desired throughput and the remaining module(s) taken offline. This may improve efficiency of the apparatus by only using the minimum number of modules necessary to meet a throughput requirement. One or more flow controllers, such as a valve block common to all modules or individual valves for each module, can be used to control flow through each module independently of flow through the others.

A radiation controller can also control the radiation source(s) of each module independently from the radiation source(s) of the other module(s). This can involve turning the radiation sources on and off or increasing or decreasing their output intensity. The radiation controller can be a switch or controller implementing a light control algorithm, for example. In one use, the radiation controller can turn off or decrease intensity of the radiation sources of any module that has low or no flow to save power. In another example, the radiation controller can control the intensity of the radiation as a continuous or stepped function of the flow rate.

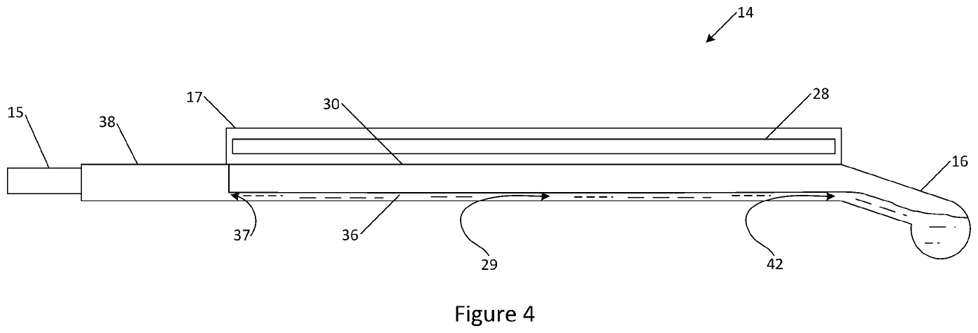

FIG. 4 shows an example liquid treatment module 14 in cross section. In this example, the module 14 is shown with a thin supercritical flow of liquid 36 in the conduit. Liquid can enter the module 14 via inlet 15, where the liquid flows into reservoir block 38 and flows out of reservoir block 38 through a gap or slot 37, and into the conduit 29. Above the conduit 29 is the lid 17, which contains the radiation source (e.g. UV bulb) 28. The base of the lid 17 includes a quartz window 30 that encloses the radiation source 28 while allowing the radiation to pass through to the liquid 36. The liquid then flows out through the exit gap 42 into the outlet 16. Although not shown in the cross-sectional side view of FIG. 4, the module 14 can include a plurality of conduits 29 (e.g. two) and a plurality of radiation sources 28 (e.g. two).

It has been found that certain inlet designs/operation can cause splashing out into the flow channel at the time of flow start up for example due to liquid rushing into an inlet that has emptied of liquid and contains air. It was found that this splashing is avoidable by several techniques. These include ensuring the conduit that feeds liquid into the inlet is angled upwards prior to the inlet to prevent the liquid draining out when not in use; by the installation of a spring loaded check valve prior to the inlet that has a similar effect of preventing draining and passage of air back up the pipe; by the use of slow ramping up of the flowrate at the flow start up (for example via a variable speed pump control or by a slow opening valve) which allows air to slowly escape the inlet rather than being rapidly forced out.

It was found that deflectors positioned above the flow channel outside the exit of the inlet were also useful in reducing any splash emitting from that area. For example, these could be plates or brushes that intercept any ejected splash. However, it was found that the inlet is not the sole source of splashes and that in various cases splashes or liquid droplets can be emitted from the supercritical flow further down the flow channel, in some cases as far two thirds of the way down the channel or further.

While there is a limit to the height of these splash/ejections it can be desirable to have elements of the treatment apparatus located below this height to ensure an overall compact system design. While this may not be a problem for supercritical flows operated at lower flowrates and larger flow depths (thicknesses), as the flow depth decreases and/or as the flowrates increase it has been found that this issue becomes more problematic.

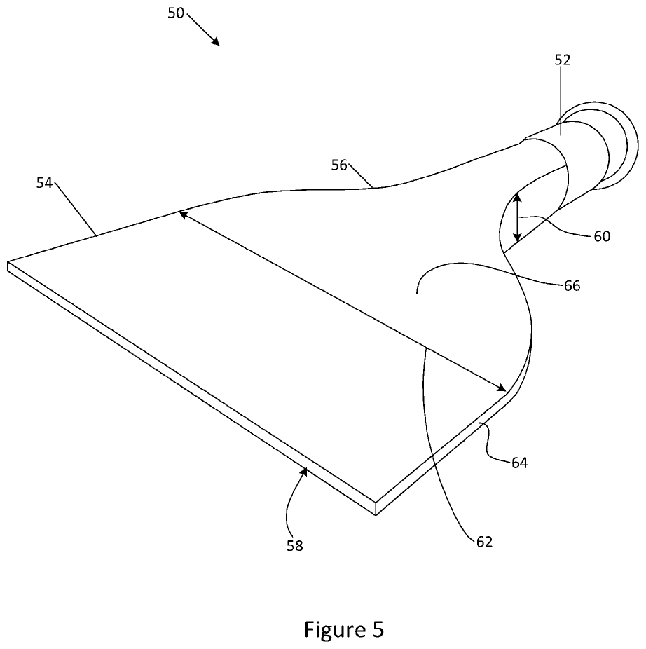

FIG. 5 shows a liquid inlet component 50 for providing a supercritical flow of liquid to a liquid conduit in a liquid treatment apparatus. For example, the liquid inlet component 50 could be used to provide a supercritical flow of liquid to the treatment apparatus of any one of FIGS. 1 to 4. In the modules 14 of FIGS. 2-4, the liquid inlet component 50 could be used in place of the reservoir block 38 or it could be shaped within the reservoir block 38. From experimental testing it was found that when liquid exited from an enclosed steel square hollow section (SHS) via a slot and was projected along a conduit as a supercritical flow, small elements of liquid ejected upwards from the conduit to the extent that splashes were seen on test paper above the liquid flow. This may have the disadvantage of potentially fouling any apparatus positioned above the channel along which the supercritical flow moves including for example lights, reflectors or quartz window/barriers. Multiple attempts were made to improve this situation for example by adding an additional internal inlet pipe into the SHS with rear facing holes to direct the inflow away from the slot but while some improvements were made none solved the problem.

However, it has been discovered that ejection of liquid elements upwards out of a supercritical flow was totally or at least substantially eliminated for a liquid that passed through an inlet component having walls that define a passage with an entry section, an exit section with substantially constant height and width, and a transitional section between the entry and exit sections. The transitional section is wider than the entry section and deeper than the exit section, allowing the liquid to spread and thin out as it moves from the entry section to the exit section.

One exemplary inlet component is detailed with reference to FIG. 5. In this inlet component 50, the liquid enters the entry section and then enters a transitional section where the area transitions in shape from the entry section to the final section by simultaneously narrowing its height while increasing its width and then enters a final section where the height and width remain constant and then exits the inlet component through an exit slot (which is the end of the exit section) to form supercritical flow along a conduit. Compared to prior inlet components that were tested, such as the enclosed steel square hollow section that received the liquid and expelled it through a slot, the inlet component either totally eliminated or produced remarkably little splashing or ejection of droplets from the main stream of the flow. It was found that use of the transitional section alone did not provide this quality of result and that the exit section was critical. Further it was also found that both these sections were playing an important role as shortening either of these sections had a negative effect on the desired result.

It has been found the flow rate that can be passed down the supercritical flow channel without incurring significant splashing is a function of flow depth where the larger the gap the higher the acceptable flowrate. It was also determined that this was not necessarily due to the increased ejection velocity that results from a smaller gap. Holding the flow depth constant, it was found that the amount of splashing or droplet ejection could be reduced to an acceptable or undetectable level using the inlet component for relatively high flow rates. An acceptable level of splashing or droplet ejection can depend on the application. It may be desirable to reduce splashing or droplet ejection to or below a very low level in applications with overhead components such as bulbs, reflectors or transmissive (e.g. quartz) windows. In trials, 33 test strips were arranged in alternating rows of two test strips and three test strips per row at a height of approximately 80 mm above a channel that was approximately 1500 mm long and 247 mm wide. The test strips were pieces of litmus paper approximately 9 mm wide with a length of approximately 68 mm. An acidic liquid was passed through the apparatus, with ejected liquid being detectable by the test strips. In these examples, a rate of ejection (that reached the test strips) of approximately 30 or fewer pinprick splashes on the test strips over a 6-hour or longer trial run was considered to be an acceptably low level of splashing or ejection.

For example, in one experimental setup an inlet component without an exit section was found to only be able to support a 90 litre per minute (l/m) flow rate with minor but acceptable splashing—a higher flow rate of 120 litre per minute (l/m) caused too much splashing and could cause unacceptable fouling of a treatment apparatus. This inlet component had a transition section with a length of about 160 mm and curved walls (similar to FIG. 5) that exited into a flow channel about 247 mm wide via a 4 mm slot. In contrast to this, an inlet component according to the design disclosed herein was able to operate at 190 l/m with no splashing at all and at 230 l/m with minor but acceptable splashing. The only difference between the inlet components in these two trials was the presence of an about 90 mm exit section in the newly designed inlet component.

An inlet component with the same about 160 mm transition section and 4 mm slot as above, but a shorter exit section of about 45 mm, was able to support flow rates of 120 l/m with minor but acceptable splashing but had an unacceptable result when operated at 160 l/m. An inlet component with an about 90 mm exit section and 4 mm slot but a shorter transition section of about 53 mm was able to support a flow rate of 120 l/m with no splashing and 150 l/m with minor but acceptable splashing but had an unacceptable result when operated at 190 l/m.

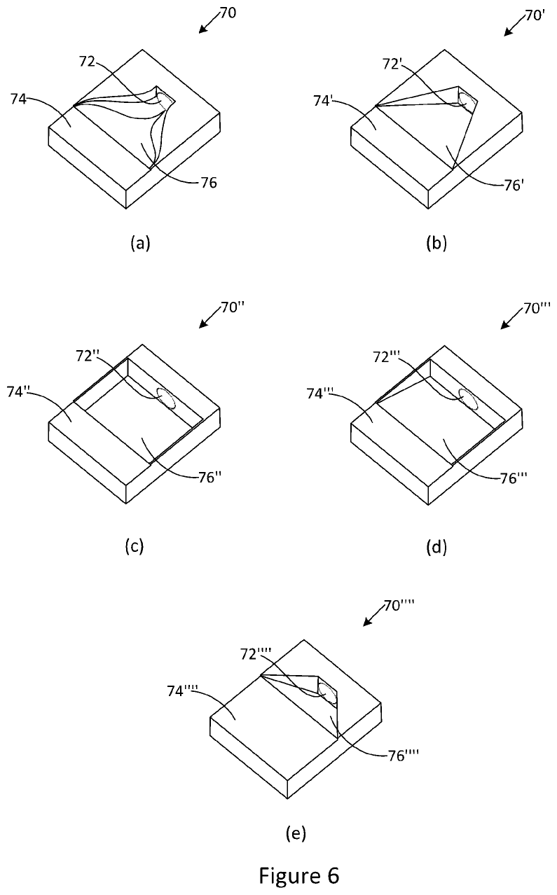

As is clear from the results above, a substantive lengthening of the exit section markedly reduces the amount of splashing or droplet ejection. Lengthening the transition section also has a substantial effect on reducing splashing and droplet ejection. Given this relationship, an inlet component can be designed to support a flow with an acceptable amount of splashing/droplet ejection, and maintain the splashing/droplet ejection at an acceptable level for higher flow rates than prior systems could, by adjusting the length of one or both of the exit section and transition section. In some examples, a length of about 45 mm or more was found to be suitable for the exit section, particularly at lower flow rates (e.g. 120 l/m for a 4 mm slot and a 250 mm wide flow channel), and about 90 mm was found to provide good results at a wide range of flow rates (e.g. 230 l/m for a 4 mm slot and a 250 mm wide flow channel). In some examples, a length of about 53 mm or more was found to be suitable for the transitional section, particularly at lower flow rates (e.g. 150 l/m for a 4 mm slot and a 250 mm wide flow channel), and a length of about 160 mm or more was found to provide good results at a wide range of flow rates (e.g. including 230 l/m for a 4 mm slot and 250 mm wide flow channel). The exemplary inlet component 70′ of FIG. 6b (with 4 mm slot and 250 mm wide flow channel) and found to provide no splashing/ejection or acceptable splashing/ejection at high flow rates, e.g. 260 l/m.

It has also been found that the inlet component can improve the shape of the downstream flow through the channel by reducing differences in depth across the width of the flow. Ridges, similar to bow waves of a boat, can form in the supercritical flow channel. These lead to areas of increased flow thickness and may result in inadequate or uneven treatment of the liquid. It was found that increasing the length of the exit section reduced these ridges. For example the inlet component 70′ of FIG. 6b was tested with an exit 74′ length of 80 mm and 160 mm with the 160 mm length being found to produce a flow in the channel with an overall flatter surface appearance.

The inlet component 50 of FIG. 5 includes one or more walls that define a liquid passage through the inlet component 50. The flow through the inlet component can be constrained at the top by a wall so that the liquid flows through under pressure. In the example of FIG. 5, the inlet component 50 has two side walls 54 and an upper wall 66. In this example the inlet component 50 has a lower wall (not shown) facing the upper wall. In other examples the inlet component can be open at the bottom and the open face then enclosed by securing the inlet component onto another surface for example the flat base of a conduit channel as is illustrated in FIG. 3. In these examples, the liquid passage is defined as being between the inlet component wall(s) and between the upper wall and the lower wall or alternatively if no lower wall is provided then between the upper wall and the base upon which the inlet component is secured in use.

The inlet component might be manufactured from plate material or from a block of material. The material could be metal such as stainless steel or aluminium or it could be plastic. In some examples the inlet component 50 can be fully or partially made from sheets/plates of material and/or tubing that are joined together, for example by screws or welding. It was however discovered that it is important that any thin material used adjacent to the flow is stiff enough or the flow can cause it to resonate and negatively impact the flow downstream from the inlet. The inlet component could include a base at the bottom of the liquid passage through the component. In another example it could be fully or partially cast for example from stainless steel or aluminium or a resin. In another example, the inlet component could be fully or partially milled from a block of material.

The inlet component could be open at the bottom (e.g. without a base along at least part of its length) so that when the block is fixed in position into a conduit the base of the conduit forms at least part of the base of the inlet component at the bottom of the liquid passage through the inlet component. In one example of an inlet component that is open at the bottom, the inlet component is milled from a block of plastic without a base in the sections 56 and 54 (that define the transition and exit sections as detailed further below). In this example, the inlet component can be formed without a base in the section 52 (that defines the entry section as detailed further below) or the section 52 could be provided by an element with a circular passage such as a bore through the block or a pipe. Other methods of inlet component manufacture are also possible including having other walls that open but which are then enclosed when in use. Having an open base or any other opening wall may offer benefits in terms of lowered manufacturing cost or may be useful if access for cleaning or other servicing for example removal of any blockage is required.

The inlet component is configured such that the liquid passage has three sections: an entry section (through section 52 of the liquid component); an exit section (through section 54 of the inlet component); and a transitional section (through section 56 of the inlet component) between the entry section and the exit section. The width dimension is indicated by the arrow 62. The height dimension is indicated by the arrow 60. Although the arrows 60 and 62 are shown at particular places along the length of the inlet component 50 in FIG. 5, the width 62 and height 60 can be measured at various points along the component 50 and different sections of the component or the passage therethrough can have different values of width 62 and height 60. The width 62 may be unchanging along the length of the exit section. The height 60 of the exit section may also be unchanging across this exit section. The width 62 of the passage through the inlet component 50 is greater at the exit section than at the entry section. For example, the width of the exit section can be about 5 times the width of the entry section so that the slot 58 from which liquid exits the inlet component 50 is 5 times as wide as the opening at which it enters the inlet component 50. The height 60 of the entry section is greater than the height of the exit section. The height of the entry section can be between about 5 and 50 times greater than the height of the exit section. The ratio of the cross-sectional area of the exit section of the passage to the cross-sectional area of the entry passage can be between about 1.3 and 0.13. The width 62 increases through the transitional section and the height 60 decreases through the transitional section.

The width 62 can increase non-linearly along the transitional section. For example, the wall(s) that define the passage can curve smoothly between the entry section and exit section so that the width smoothly increases between the entry section and exit section. The width can initially increase superlinearly from the entry section towards a central portion of the transitional section then increase sublinearly from the central portion to the exit portion. In other words, the sides of the passage (e.g. as defined by side walls 64) can initially curve outwards from the entry section then curve inwards towards the exit section. In other words, the second derivative of width with respect to length along the passage is positive between the entry section and the central portion of the transitional section and is negative between the central portion of the transitional section and the exit section. Note that the central portion need not be halfway along the transitional section and it may be at various places between the two ends of the transitional section.

It is the configuration of the inner surfaces of the walls that is important for defining the shape and sections of the passage. The exterior shape of the inlet component 50 could vary without affecting the configuration of the liquid passage and without affecting the flow properties of liquid passing through the inlet component.

Flow controlling elements may be incorporated within the inlet component for example these could include flow baffles, flow vanes, groves or conduits that act to direct the flow from the entry section to or into the exit section.

FIGS. 6a-6e show some other inlet components 70, 70′. 70″, 70″, 70″ according to the new design disclosed herein. The inlet components 70, 70′. 70″, 70′″, 70′″ are shown upside down so that the passages through them, which are formed in the undersides of the inlet components, can be seen. These inlet components may be formed from a block of material. For example, they could be milled out of a block of plastic. In FIG. 6, the inlet components are shown without a bottom wall. Each of these could be secured to the bottom of a treatment conduit, which would then provide the bottom wall defining the passage through the inlet component. In alternative examples, the inlet components 70, 70′. 70″, 70″, 70′″ could have bottom walls, for example in the form of sheets of material secured to their bottoms.

The inlet components 70, 70′ and 70″ correspond to the designs tested in the trials discussed above. Other designs, such as the inlet components 70″ and 70″, are possible and may achieve similar advantageous results.

The inlet component 70 of FIG. 6a has an entry section 72, exit section 74 and transition section 76. The transitional section 76 has curved sides similar to examples discussed previously. The transitional section 74 simultaneously widens and thins (vertically) from the entry section 72 towards the exit section 74. The shape of the passage through the inlet component 70 can be the same as or similar to that of the inlet component 50 of FIG. 5.

The inlet component 70′ of FIG. 6b has similar entry 72′ and exit 74′ sections to those of the inlet component 70 but a different transitional section 76′. The transitional section 76′ widens (horizontally) and thins (vertically) linearly, having flat side and upper walls. In this example, the width of the inlet component is 247 mm and the overall length is 300 mm. The length of the entry section 72′ is 50 mm, the length of the transitional section 76′ is 170 mm and the length of the exit section 74′ is 80 mm. The height of the exit section 74′ is 4 mm. The entry section 72′ is circular in cross section, having a diameter (therefore also a height and width) of 57 mm.

The inlet component 70″ of FIG. 6c has a simple cuboid transitional section 76″ between the entry section 72″ and the exit section 74″.

FIG. 6d shows a proposed design for an inlet component 70″ having a transitional section 76″ with a constant width but decreasing thickness (vertically) between the entry section 72″ and the exit section 74″.

FIG. 6e shows a proposed design for an inlet component 70″″ that is similar to the inlet component 70′ except that the transitional section 76″ has been shortened to 90 mm and the exit section 74″″ has been lengthened to 160 mm. The entry section 72″″ is unchanged.

In the inlet components described previously, the entry section can be arranged at various angles to introduce liquid flow at different angles, not just horizontally as shown in the figures. For example, it could enter from the top or bottom of the inlet component. In these arrangements, the inlet dimensions referred to as height and width are to be understood to refer to two perpendicular dimensions that are transverse to the liquid flow.

Although all of the inlet components 70, 70′. 70″, 70′″, 70″ are designed to decrease splashing and droplet ejection, some may be better suited to certain applications than others. For example, material such as particulates or slime may build up in the corners of the squarer transition sections 76″, 76′″ of the inlet components 70″, 70″. This may make them more suitable for use with liquid that is relatively free of such materials or organics compounds materials that may cause bacterial slime to grow, whereas the inlet components 70, 70′, 70″ may be better choices for treating liquid with such material, for example effluent. On the other hand, the inlet components 70″, 70″ may be easier and more cost effective to manufacture than inlet components 70, 70′, 70″, making them potentially more suitable to applications where cost effectiveness is important. Regarding splashing and droplet ejection, testing to date has shown inlet components 70 and 70′ to be the most effective, with inlet component 70′ being slightly more effective than inlet component 70.

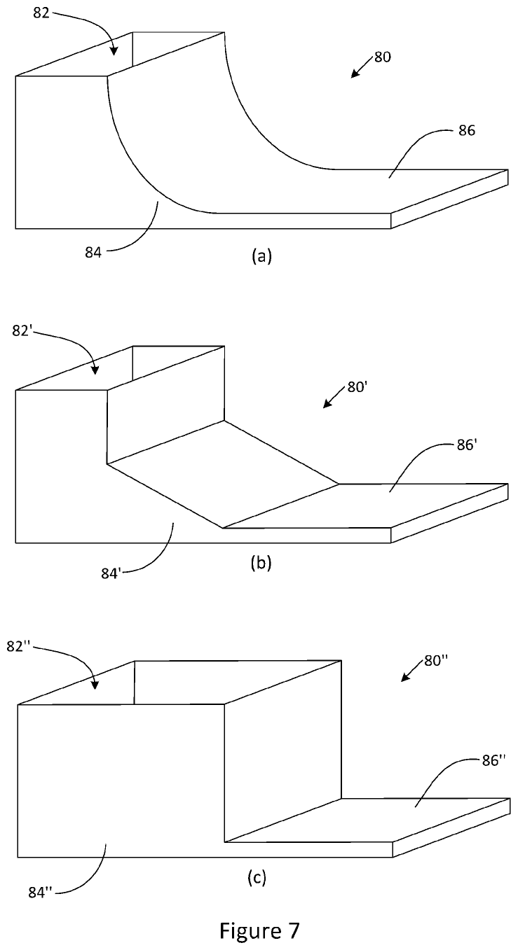

Alternative forms of inlet component 80, 80′, 80″ are shown in FIGS. 7a-7c. These inlet components can be used in a liquid treatment apparatus in which a supercritical flow of liquid flows down a conduit and is treated with radiation in the conduit. The inlet components have walls which define a passage for liquid through the component. In these designs, liquid flows from a second section 84, 84′, 84″ to a first section 86, 86′, 86″. The first section 86, 86′, 86″. is configured as an exit section, along the length of which the height and width are substantially unchanged. The end of the first section is a slot from which liquid exits the inlet component into a conduit for treatment. The slot can have a height of less than 6 mm, 6 mm, or greater than 6 mm.

The second section can gradually change height as shown in FIGS. 7a and 7b or not, as shown in FIG. 7c. In some examples, liquid can flow into the second section via an open mouth 82, 82′, 82″. The liquid may flow into the mouth at a sufficient speed to produce supercritical flow in the conduit. Alternatively, the second section can be a reservoir configured to hold a sufficient height of liquid such that the pressure head is sufficient to produce supercritical flow in the conduit.

The lengths of sections of the inlet components 80, 80′, 80″ can be selected to reduce splashing and liquid ejection in the same manner as the inlet components previously discussed. The lengths of the first sections 86, 86′, 86″ of the inlet components 80, 80′, 80″ can be the same as the exit sections of the inlet components previously discussed. The lengths of the second sections 84, 84′, 84″ of the inlet components 80, 80′, 80″ can be the same as the transitional sections of the inlet components previously discussed.

The inlet components can be expected to work in a similar manner at different scales provided they are scaled with geometric and dynamic similarity.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. An apparatus for treating a liquid, the apparatus having a frame and one or more treatment module(s) where each module includes:
i. a liquid inlet for receiving liquid from a liquid source:
ii. a liquid outlet for discharging liquid to a liquid drain;
iii. one or more liquid conduits between the liquid inlet and the liquid outlet; and
iv. one or more radiation sources for treating the liquid in that module:
wherein one or more of the treatment modules is movable relative to the frame without disconnection of the module(s) from the liquid source or disconnection of the module(s) from the liquid drain.

2. The apparatus of claim 1 wherein at least one of the treatment modules has an opening lid and allows access into the module when its lid is open.

3. The apparatus of claim 1 wherein the frame is a rack.

4. (canceled)

5. The apparatus of claim 3 wherein each of the one or more movable modules is mounted to the rack on rails so that it can slide out from the rack.

6. The apparatus of claim 1 wherein the liquid inlet is configured to be movably coupled to the liquid source.

7. The apparatus of claim 6 wherein the liquid inlet includes a flexible inlet conduit.

8. The apparatus of claim 7 wherein the flexible inlet conduit is a hose.

9-11. (canceled)

12. The apparatus of claim 1 wherein the liquid outlet is configured to be movable while maintaining any discharge into the liquid drain.

13-15. (canceled)

16. The apparatus of claim 12 wherein the liquid outlet is configured to be slidably connected to the liquid drain.

17. (canceled)

18. The apparatus of claim 12 wherein the liquid outlet and/or a connection to it is/are configured to move within an elongate recess of the liquid drain.

19. The apparatus of claim 1 further comprising the liquid drain.

20. The apparatus of claim 19 configured such that an opening from which liquid flows out of the liquid outlet, or a connection to it, remains within the liquid drain to retain liquid in the apparatus when the respective module is moved relative to the frame.

21. The apparatus of claim 1 configured to support open channel flow of liquid through the liquid conduit(s).

22. The apparatus of claim 21 configured to support supercritical flow of liquid through the liquid conduit(s).

23. The apparatus of claim 2 wherein the one or more radiation sources of each module are located in the lid in a space that is enclosed by a radiation-transmissive window when the lid is closed and the apparatus is in use.

24. (canceled)

25. The apparatus of claim 1 wherein the apparatus is configured to treat a plurality of separate flows of liquid through respective separate ones of a plurality of treatment modules.

26-28. (canceled)

29. The apparatus of claim 1 wherein the apparatus is 1 m or less in width.

30. (canceled)

31. The apparatus of claim 1 wherein the radiation sources include UV radiation sources.

32-45. (canceled)

46. An apparatus for treating a liquid, the apparatus including:
i. a frame: and
ii. a plurality of treatment modules supported by the frame, each treatment module having one or more liquid conduits therethrough and one or more radiation sources for treating the liquid in that module:
wherein the apparatus is configured to treat a plurality of separate flows of liquid through respective separate ones of the treatment modules:
and wherein at least one of the treatment modules has an opening lid and the module is movable relative to the frame and allows access into the module when its lid is open.

47. The apparatus of claim 46 wherein each of a plurality of the treatment modules has an opening lid, is movable relative to the frame, and allows access into the module when its lid is open.

48. The apparatus of claim 46 wherein the frame is a rack, wherein each of the at least one movable modules is configured to be pulled out from the rack

49. (canceled)

50. The apparatus of claim 48 wherein each of the at least one movable modules is mounted to the rack on rails so that it can slide out from the rack.

51. The apparatus of claim 46 further comprising a flow controller configured to allow flow through each module to be controlled independently of the flow through the other modules.

52. The apparatus of claim 51 wherein the flow controller is configured to control the number of modules through which the liquid flows to control throughput of the apparatus.

53. The apparatus of claim 46 further including a radiation source controller for controlling activation of the radiation source(s) of each module independently of the activation of the radiation source(s) of the other module(s).

54. The apparatus of claim 53 wherein the radiation source controller is configured to control activation of the radiation source(s) of each module depending on liquid flow through the respective module.

55. The apparatus of claim 46 wherein the apparatus is configured to support open channel flow of the liquid through the liquid conduits.

56. The apparatus of claim 55 wherein the apparatus is configured to support supercritical flow of the liquid through the liquid conduit(s).

57. The apparatus of claim 46 wherein the one or more radiation sources of each module are located in the lid of the module in a space that is enclosed by a radiation-transmissive window when the lid is closed and the apparatus is in use.

58. (canceled)

59. The apparatus of claim 46 wherein one or more of the treatment modules is movable relative to the frame without disconnection of the module from a liquid source or disconnection of the module from a liquid drain.

60-61. (canceled)

62. The apparatus of claim 46 wherein the apparatus is 1 m or less in width.

63. The apparatus of claim 46 wherein the radiation sources include at least one UV radiation source.

64-70. (canceled)

71. The method of apparatus of claim 46 further configured to detect movement of a module and, in response, cut off flow of liquid through that module.

72-94. (canceled)

95. A liquid treatment module comprising:
i. a body containing one or more conduits for conveying a liquid to be treated from an inlet to an outlet;
ii. a lid including one or more radiation sources for treating a liquid flowing through the conduit(s); and
iii. one or more radiation-transmissive windows configured to enclose the radiation source(s) when the lid is closed and the module is in use;
wherein the lid is movable relative to the body from a closed position to an open position.

96. The liquid treatment module of claim 95 wherein the conduit(s) is/are configured to support open channel flow of the liquid.

97. The liquid treatment module of claim 96 wherein the conduit(s) is/are configured to support supercritical flow of the liquid.

98. The liquid treatment module of claim 97 further comprising a slot configured to allow liquid to flow through the slot into the conduit(s) and generate supercritical flow.

99. The liquid treatment module of claim 95 configured such that a) walls of the conduit, b) the radiation-transmissive windows, or c) a slot through which liquid enters the conduit(s) from the inlet can be accessed when the lid is moved to the open position.

100. The liquid treatment module of claim 95 wherein the window forms the base of the lid.

101. The liquid treatment module of claim 95 wherein the window(s) is/are hingedly connected to the lid or conduit.

102. The liquid treatment module of claim 95 wherein the window(s) is/are embedded in the lid.

103. The liquid treatment module of claim 95 wherein the window(s) is/are separable from the lid.

104. The liquid treatment module of claim 95 wherein the radiation source is located in a space enclosed by the window(s) when the lid is closed and the apparatus is in use and wherein the liquid treatment module further comprises an airflow controller for controlling a flow of air in the space enclosed by the window(s).

105. The liquid treatment module of claim 95 wherein the module is 1 m or less in width.

106. (canceled)

107. The liquid treatment module of claim 95 further comprising one or more sensors to detect movement or position of the lid and a controller for stopping flow of liquid through the conduit(s) and/or operation of the radiation source upon detection that the lid is open or is being opened.

108-110. (canceled)

111. A liquid treatment apparatus including:
a liquid conduit;
a liquid inlet component configured to provide a supercritical flow of liquid in the liquid conduit for radiation treatment of the supercritical flow, wherein the liquid inlet component comprises one or more walls configured to define a liquid passage through the liquid inlet component, the liquid passage comprising:
i. an entry section having a first dimension transverse to a direction of flow of liquid through the entry section and a second dimension transverse to the direction of flow of liquid through the entry section and perpendicular to the first dimension;
ii. an exit section terminating in an exit slot, the exit section having a length, an exit section height that is less than the first dimension of the entry section and an exit section width that is greater than the second dimension of the entry section, wherein the exit section height and the exit section width are substantially unchanged over the length of the exit section; and
iii. a transitional section between the entry section and the exit section, wherein the transitional section has a transitional section width that is greater than the second dimension of the entry section and a transitional section height that is greater than the exit section height.

112-113. (canceled)

114. The liquid treatment apparatus of claim 111 wherein the ratio of the exit section width to the second dimension of the entry section is approximately 5:1.

115. The liquid treatment apparatus of claim 111 wherein the ratio of the first dimension of the entry section to the exit section height is between about 5:1 and 50:1.

116. The liquid treatment apparatus of claim 111 wherein the ratio of the cross-sectional area of the passage at the exit section to the cross-sectional area of the passage at the entry section is between approximately 1.3:1 and approximately 0.13:1.

117. (canceled)

118. The liquid treatment apparatus of claim 111 wherein the transitional section width increases gradually with distance from the entry section to the exit section.

119. The liquid treatment apparatus of claim 118 wherein the transitional section height decreases gradually with distance from the entry section to the exit section.

120-121. (canceled)

122. The liquid treatment apparatus of claim 111 further comprising a radiation source arranged to treat liquid in the conduit.

123. (canceled)

124. The liquid treatment apparatus of claim 123 wherein the radiation source is arranged above the conduit such that it is external from the supercritical flow of liquid through the conduit.

125. The liquid treatment apparatus of claim 111 wherein the length of the exit section and/or a length of the transitional section is/are selected such that an amount of liquid ejected from the main stream of the supercritical flow is below a threshold for liquid flow rates below a threshold.

126-130. (canceled)

131. The liquid treatment apparatus of claim 111 wherein the length of the exit section is selected such that differences in depth of the supercritical flow of the liquid in the conduit are below a threshold.

132-145. (canceled)
